(19) United States
(12) Patent Application Publication
(10) Pub. No.: US 2007/0193459 A1
(43) Pub. Date: Aug. 23, 2007

(54) PLATE FOR ROTARY SCREEN APPARATUS AND METHOD OF MANUFACTURING THE SAME

(75) Inventor: Toshiyuki Aoki, Noda-shi (JP)

Correspondence Address: BIRCH STEWART KOLASCH & BIRCH, PO BOX 747, FALLS CHURCH, VA, 22040-0747, US

(73) Assignee: KOMORI CORPORATION, Tokyo (JP)

(21) Appl. No.: 11/673,438

(22) Filed: Feb. 9, 2007

(30) Foreign Application Priority Data
Feb. 10, 2006 (JP) 2006-033203

(51) Int. Cl. B41C 3/08

(52) U.S. Cl. 101/401.1

(57) ABSTRACT

A screen is manufactured by carrying out a step of electroforming a base layer and a step of electroforming a protection layer. In the base layer electroforming step, a cylindrical mother die with a copper circumferential surface is immersed in an electroforming solution containing nickel ions. Then, while electric current is allowed to flow between the mother die and a nickel electrode plate, the mother die is rotated. Thus, a nickel base layer is formed on the circumferential surface of the mother die. In the protection layer electroforming step, a first masking material is provided at a certain predetermined position on the base layer. Then, while electric current is allowed again to flow, the mother die is rotated. Thus, a nickel protection layer is formed on the base layer avoiding the position on the masking material.

### BACKGROUND OF THE INVENTION

1. Field of the Invention

The present invention relates to a plate for rotary screen apparatus that performs printing or coating by supplying liquid, such as ink and varnish, with a squeegee through holes formed in a plate, such as a screen, to a sheet, such as a paper sheet, held by an impression cylinder. Particularly, the plate for rotary screen apparatus of the present invention is effective, when the liquid supply apparatus is applied to a screen printing unit of a printing press that performs screen printing on a paper sheet.

2. Description of the Related Art

A conventional procedure of screen printing on a paper sheet is as follows. A rotary screen apparatus is used. The rotary screen apparatus holds a cylindrical thin screen in which small holes corresponding to a pattern are formed, and is provided with a squeegee placed inside the screen. Liquid such as ink and varnish, which is stored inside the screen, is squeezed out by the squeegee through the small holes of the screen. In this way, a screen printing corresponding to the pattern is performed on a paper sheet held by an impression cylinder using the liquid such as ink and varnish. Since the rotary screen apparatus can perform thickly embossed printing on a paper sheet with a special ink, the rotary screen apparatus is used for the purpose of giving a high-quality look and touch.

Such a rotary screen apparatus that performs printing on a paper sheet has the following features. For example, in Japanese Patent Translation Publication No. 2000-504643 and the like, grippers and gripper pads are provided in a gap portion formed in an impression cylinder to prevent the grippers and the gripper pads from projecting out from the outer peripheral surface of the impression cylinder. A cover that can be opened and closed is provided to cover the gap portion. When a paper sheet is held and released, the opening and closing operations of the cover are synchronized with those of the grippers. In this way, while holding and releasing a paper sheet is made possible, the screen is prevented from falling into the gap portion of the impression cylinder and from coming into contact with the grippers (projections). As a result, any damage on the screen, which might otherwise take place, is precluded.

Such an apparatus structure as the one described in the above-mentioned Japanese Patent Translation Publication No. 2000-504643 and the like, however, has a problem. The screen biased outwards in a radial direction by the squeegee is abruptly pulled outwards in a radial direction by a length t equivalent to the thickness of the paper sheet when the screen transfers from a surface of the paper sheet to a surface of the impression cylinder. The screen thus pulled outwards may possibly get damaged, so that the service life of the screen may possibly be shortened.

The kind of problem mentioned above may occur not only in a case where thickly embossed printing is performed on a paper sheet with a special ink, but also, in a similar manner, in a case where liquid is supplied, to a sheet held by an impression cylinder, with a squeegee through holes formed in the plate for rotary screen apparatus. For example, such a problem may occur in a case of applying varnish to an entire surface of a paper sheet.

### SUMMARY OF THE INVENTION

Under the circumstances, the present invention provides a plate for rotary screen apparatus and a method of manufacturing the plate for rotary screen apparatus in which the damage done when the liquid is supplied is made to be minimum and thus a plate is made to have a longer service life.

To solve the above-described problem, the method of manufacturing the plate for rotary screen apparatus of the present invention provides the following characteristics. The method of manufacturing the plate for rotary screen apparatus includes a step of forming a first nickel-plated layer by plating nickel on a mother die. The method also includes a step of forming a second nickel-plated layer on a surface where the first nickel-plated layer is exposed. The second nickel-plated layer is formed by plating nickel on the surface of the first nickel-plated layer with a first masking material provided thereon so that a part of the surface of the first nickel-plated layer may be exposed.

In addition, the method of manufacturing the plate for rotary screen apparatus of the present invention provides the following characteristics. In the above-described method of manufacturing the plate for rotary screen apparatus, the method further includes a step of forming a third nickel-plated layer on a surface where the second nickel-plated layer is exposed. The third nickel-plated layer is formed by plating nickel on the surface of the second nickel-plated layer with a second masking material provided thereon so that a part of the surface of the second nickel-plated layer may be exposed.

In addition, the method of manufacturing the plate for rotary screen apparatus of the present invention provides the following characteristics. In the above-described method of manufacturing the plate for rotary screen apparatus, the nickel plating is carried out while the mother die is being rotated.

In addition, the method of manufacturing the plate for rotary screen apparatus of the present invention provides the following characteristics. In the above-described method of manufacturing the plate for rotary screen apparatus, the mother die has a cylindrical or a columnar shape.

In addition, the method of manufacturing the plate for rotary screen apparatus of the present invention provides the following characteristics. In the above-described method of manufacturing the plate for rotary screen apparatus, the mother die has multiple dimples in the outer surface thereof, and the dimples of the mother die is filled up with a masking material for holes.

In addition, the method of manufacturing the plate for rotary screen apparatus of the present invention provides the following characteristics. In the above-described method of manufacturing the plate for rotary screen apparatus, after the plate for rotary screen apparatus is formed with the nickel-plated layers, the plate is subjected to a step of filling up, with a photosensitive material, the holes formed in the surface of the nickel-plated layers, and then to a step of removing the photosensitive material from the holes of the nickel-plated layers corresponding a pattern.

On the other hand, the plate for rotary screen apparatus of the present invention for solving the above-described problem has in a cylindrical shape to face and be brought into contact with an impression cylinder that holds a sheet on its outer peripheral surface, and is rotatably supported. The plate for rotary screen apparatus has holes formed in its circumferential surface, and, through the holes, a liquid pooled inside the plate is supplied to the sheet with a squeegee placed inside the plate. The plate for rotary screen apparatus of the present invention provides the following characteristics. The plate for rotary screen apparatus is made of nickel plating. A portion of the outer peripheral surface of the impression cylinder, on which portion no sheet is held, faces a portion of the plate. At least a part, in the axial directions, of the portion of the plate has a thickness made up by adding the thickness of the sheet and the thickness of a portion of the plate in the rotary screen apparatus, which portion faces the surface of the sheet held on the outer peripheral surface of the impression cylinder.

In addition, the plate for rotary screen apparatus of the present invention provides the following characteristics. In the above-described the plate for rotary screen apparatus, the plate for rotary screen apparatus is formed in the following way. The plate has the portion with the thickness made up by adding the thickness of the sheet and the thickness of the portion of the plate, which portion faces the surface of the sheet held on the outer peripheral surface of the impression cylinder. The above-mentioned portion that the plate has is continuous all along the length, in the rotational direction, of a portion of the plate for rotary screen apparatus, which portion faces the outer peripheral surface of the impression cylinder, where no sheet is held all along the length in the axial direction.

In addition, the plate for rotary screen apparatus of the present invention provides the following characteristics. In the above-described plate for rotary screen apparatus, the portion of the plate, which portion faces the surface of the sheet held on the outer peripheral surface of the impression cylinder, is composed of a base layer with holes formed in the circumferential surface. In addition, the portion with the thickness made up by adding the thickness of the sheet and the thickness of the portion of the plate, which portion faces the surface of the sheet held on the outer peripheral surface of the impression cylinder, is composed of the base layer and a protection layer formed thereon. The protection layer has a thickness equal to that of the sheet.

In addition, the plate for rotary screen apparatus of the present invention provides the following characteristics. In the above-described plate for rotary screen apparatus, the impression cylinder includes a cover member in a gap portion. The gap portion is formed in the outer peripheral surface of the impression cylinder. In the gap portion, sheet-holding means is installed. The sheet-holding means holds the front end side of the sheet, and makes the sheet be held on the outer peripheral surface of the impression cylinder. While the cover member allows the sheet-holding means to hold the sheet, the cover member connects the end portion of the gap portion, at the downstream side in the rotational direction, and the end portion at the upstream side.

In addition, the plate for rotary screen apparatus of the present invention provides the following characteristics. In the above-described plate for rotary screen apparatus, the portion of the plate for rotary screen apparatus, which portion faces the surface of the sheet held on the outer peripheral surface of the impression cylinder is composed of a base layer with holes formed in the circumferential surface. In addition, the portion with the thickness made up by adding the thickness of the sheet and the thickness of the portion of the plate for rotary screen apparatus, which portion faces the surface of the sheet held on the outer peripheral surface of the impression cylinder, is composed of the base layer and a protection layer formed thereon. The protection layer has a thickness equal to that of the sheet. Moreover, at least a part, in the axial directions, of the portion of the plate for rotary screen apparatus, which portion faces the cover member of the impression cylinder, has a thickness made up by adding: the thickness of the portion of the plate for rotary screen apparatus, which portion of the plate faces the surface of the sheet held on the outer peripheral surface of the impression cylinder; the thickness of the sheet; and the length equivalent to the shortest distance between the tracing of the outer peripheral surface of the impression cylinder and the surface of the cover member, is formed in the following way. A reinforcement layer that has a thickness equal to the length equivalent to the shortest distance between the tracing of the outer peripheral surface of the impression cylinder and the surface of the cover member is formed on the protection layer formed on the base layer.

### BRIEF DESCRIPTION OF THE DRAWINGS

The present invention will become more fully understood from the detailed description given hereinbelow and the accompanying drawings which are given by way of illustration only, and thus are not limitative of the present invention and wherein;

FIG. 1 shows an overall schematic configuration view according to a first embodiment of a printing press that uses a plate for rotary screen apparatus of the present invention;

FIG. 2 shows an enlarged view of a part extracted as indicated by an arrow II in FIG. 1;

FIG. 3 shows an enlarged view of an extracted main part of FIG. 2;

FIG. 4 shows a plan view of an impression cylinder of FIG. 2;

FIG. 5 shows an axial sectional view of a main part of a rotary screen apparatus of FIG. 2;

FIG. 6 shows a schematic configuration view of an apparatus for manufacturing a screen of FIG. 2;

FIGS. 7A to 7C show explanatory drawings showing processes in a method of manufacturing the screen of FIG. 2;

FIGS. 8D to 8G show explanatory drawings showing processes coming after the processes in FIGS. 7A to 7C in the method of manufacturing the screen of FIG. 2;

FIGS. 9H to 9J show drawings showing processes coming after the processes in FIGS. 8D to 8G in the method of manufacturing the screen of FIG. 2;

FIG. 10 shows a schematic configuration view according to a second embodiment of the plate for rotary screen apparatus of the present invention;

FIG. 11 shows an overall schematic configuration view according to an eighth embodiment of a printing press that uses the plate for rotary screen apparatus of the present invention;

FIG. 12 shows an overall schematic configuration view of a printing press in which a liquid supply apparatus of the present invention is applied to a screen printing unit according to another embodiment;

FIG. 13 shows an overall schematic configuration view of a printing press in which a liquid supply apparatus of the present invention is applied to a screen printing unit according to another embodiment;

FIGS. 14A and 14B show schematic configuration views of main portions according to other embodiments of a printing press that uses the plate for rotary screen apparatus of the present invention; and

FIG. 15 shows an enlarged view of a main part extracted from FIG. 14.

### DETAILED DESCRIPTION OF THE INVENTION

Explanations will be given hereinbelow of embodiments of the plate for rotary screen apparatus of the present invention and of a method of manufacturing the plate by referring to the accompanying drawings. The present invention, however, is not limited to the embodiments below.

### First Embodiment

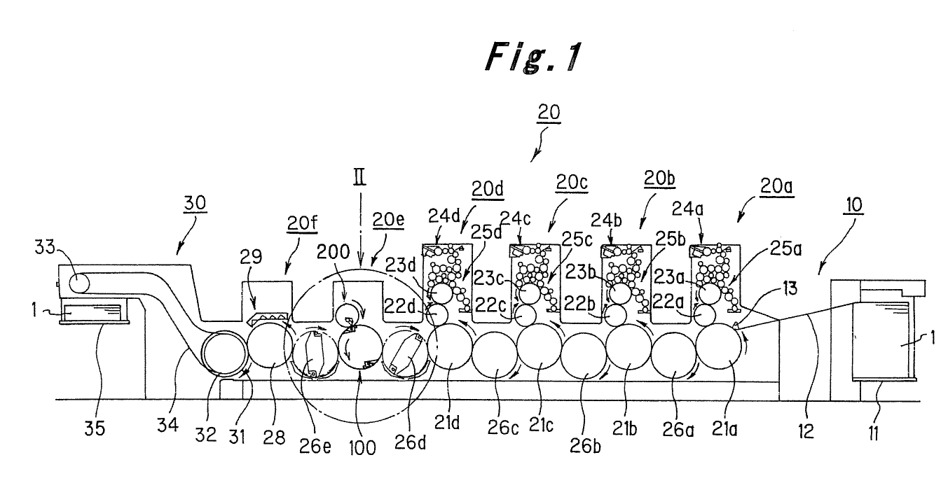

Explanations will be given of a first embodiment of the plate for rotary screen apparatus and of the method of manufacturing the plate of the present invention by referring to FIGS. 1 to 9.

As shown in FIG. 1, a feeder tray 11 is provided to a feeder 10. A feeder board 12 is provided to a feeder 10, and a paper sheet 1, which is a sheet on the feeder tray 11, is fed to a printing unit 20 one by one with the feeder board 12. A swing arm shaft pregripper 13 is provided on a front end of the feeder board 12. The paper sheet 1 is passed to an impression cylinder 21a of a first offset printing unit 20a of the printing unit 20 with the swing arm shaft pregripper 13.

In the first offset printing unit 20a of the printing unit 20, a blanket cylinder 22a faces and is brought into contact with the impression cylinder 21a, at a position further downstream in the rotational direction of the impression cylinder 21a than the swing arm shaft pregripper 13. A plate cylinder 23a faces and is brought into contact with the blanket cylinder 22a, at a position further upstream in the rotational direction of the blanket cylinder 22a than the impression cylinder 21a. An ink supplying unit 24a is provided at a position further upstream in the rotational direction of the plate cylinder 23a than the blanket cylinder 22a. A damping unit 25a is provided at a position further upstream in the rotational direction of the plate cylinder 23a than the ink supplying unit 24a.

The impression cylinder 21a of the first offset printing unit 20a faces and is brought into contact with a transfer cylinder 26a at a position further downstream in the rotational direction of the impression cylinder 21a than the blanket cylinder 22a. An impression cylinder 21b of a second offset printing unit 20b faces and is brought into contact with the transfer cylinder 26a. Thus, the impression cylinders 21a and 21b face each other, and are, indirectly, brought into contact with each other with the transfer cylinder 26a intervening in between. This second offset printing unit 20b, as is the case of the first offset printing unit 20a, has a blanket cylinder 22b, a plate cylinder 23b, an ink supplying unit 24b, a damping unit 25b and the like.

In addition, the impression cylinder 21b of the second offset printing unit 20b faces and is brought into contact with a transfer cylinder 26b at a position further downstream in the rotational direction of the impression cylinder 21b than the blanket cylinder 22b. An impression cylinder 21c of a third offset printing unit 20c faces and is brought into contact with the transfer cylinder 26b. Thus, the impression cylinders 21b and 21c face with each other, and are, indirectly, brought into contact with each other with the transfer cylinder 26b intervening in between. This third offset printing unit 20c, also as is the case of the first and the second offset printing units 20a and 20b, has a blanket cylinder 22c, a plate cylinder 23c, an ink supplying unit 24c, a damping unit 25c and the like.

Moreover, the impression cylinder 21c of the third offset printing unit 20c faces and is brought into contact with a transfer cylinder 26c at a position further downstream in the rotational direction of the impression cylinder 21c than the blanket cylinder 22c. An impression cylinder 21d of a fourth offset printing unit 20d faces and is brought into contact with the transfer cylinder 26c. Thus, the impression cylinders 21c and 21d face each other, and are, indirectly, brought into contact with each other with the transfer cylinder 26c intervening in between. This fourth offset printing unit 20d, also as is the case of the first to the third offset printing units 20a to 20c, has a blanket cylinder 22d, a plate cylinder 23d, an ink supplying unit 24d, a damping unit 25d and the like.

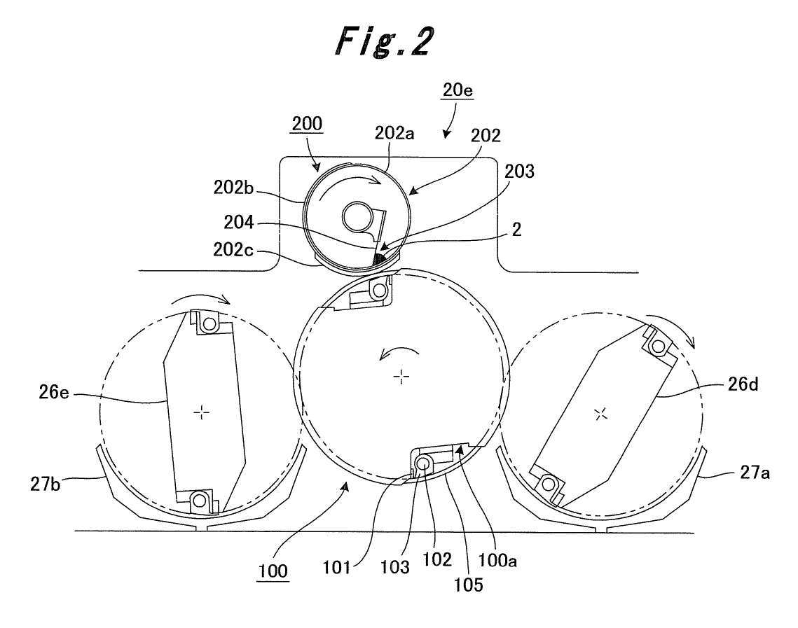

As shown in FIGS. 1 and 2, the impression cylinder 21d of the fourth offset printing unit 20d faces and is brought into contact with a transfer cylinder 26d at a position further downstream in the rotational direction of the impression cylinder 21d than the blanket cylinder 22d. An impression cylinder 100 of a screen printing unit 20e, which is a liquid supply apparatus, faces and is brought into contact with the transfer cylinder 26d. Thus, the impression cylinders 21d and 100 face each other, and are, indirectly, brought into contact with each other with the transfer cylinder 26d intervening in between. Note that, as is described in Japanese Patent Application Publication No. 2004-099314, the transfer cylinder 26d is a skeleton cylinder (solid cylinder) and has a guiding unit 27a which is provided therebelow, and which blows out air to guide the transfer of the paper sheet 1. The impression cylinder 100 has the following structure.

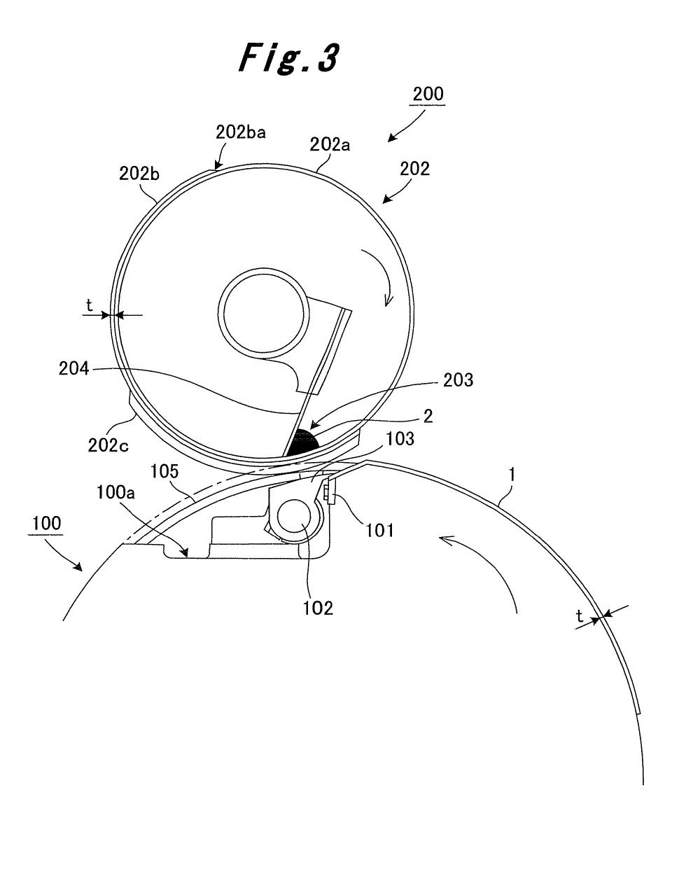

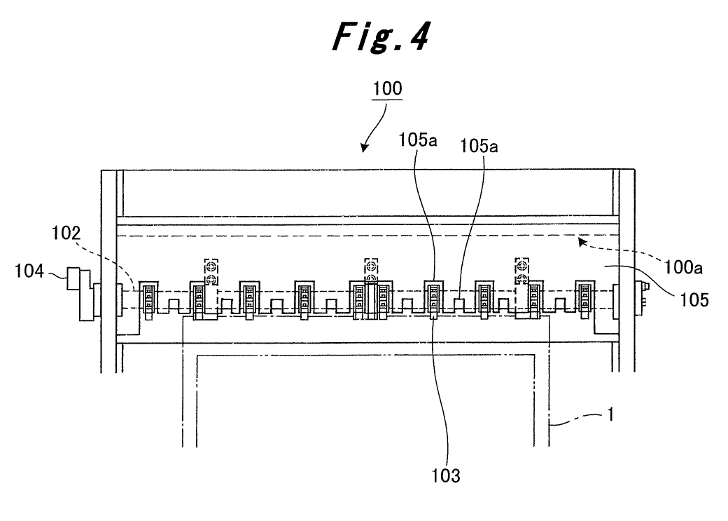

As shown in FIGS. 2 to 4, a plurality of gap portions 100a (specifically, two gap portions 100a, in this embodiment), each of which is formed along the axial directions of the impression cylinder 100, are formed in the outer peripheral surface of the impression cylinder 100 at even intervals along the circumferential direction of the impression cylinder 100. A plurality of gripper pads 101 are provided at certain predetermined intervals along the axial directions of the impression cylinder 100 in each of the gap portions 100a of the impression cylinder 100. The gripper pads 101 are provided at an end located at an upstream side (at a first side in the circumferential direction, i.e., at the right side in FIG. 3 and at the downside in FIG. 4) in the rotational direction of the impression cylinder 100. The gripper pads 101 are provided as being drawn inwards to the axis of the impression cylinder 100 from the outer peripheral surface of the impression cylinder 100.

A gripper shaft 102 is provided in the gap portion 100a of the impression cylinder 100, while the gripper shaft 102 is arranged with its longer side oriented along the axial directions of the impression cylinder 100. The gripper shaft 102 is supported as being capable of rotating relatively to the impression cylinder 100. A plurality of grippers 103 are provided to the gripper shaft 102 at certain predetermined intervals along the axial directions of the impression cylinder 100 in each of the gap portions 100a of the impression cylinder 100, while the front end side of each gripper 103 is placed on the corresponding one of the gripper pads 101.

In other words, the distance between the axis and each gripper pad 101 in the impression cylinder 100 is made to be the same as that in each one of the impression cylinders 21a to 21d and the transfer cylinders 26a to 26d. The distance in the impression cylinder 100 is also made to be the same as that in each one of a transfer cylinder 26e, a transport cylinder 28, and a delivery cylinder 31, all of which are described later. At the same time, the distance between the axis and the outer peripheral surface in the impression cylinder 100 is made to be larger than that in each of the rest of these cylinders mentioned above. As a result, while the gripper pads 101 and grippers 103 are prevented from projecting out from the outer peripheral surface of the impression cylinder 100, the impression cylinder 100 can transfer the paper sheet 1 from the transfer cylinder 26d to the transfer cylinder 26e. In addition, the impression cylinder 100 can hold the paper sheet 1 on the outer peripheral surface thereof by holding, with the gripper 103 and the like, the front end side of the paper sheet 1.

Additionally, a gap guard 105, which is a cover member of an arc-shape plate, is fixed to the inside of each of the gap portions 100a of the impression cylinder 100. The gap guard 105 connects the two end portions of the gap portion 100a, that is, the end portion at the downstream side in the rotational direction and the end portion at the upstream side, while the connection is made at a position closer to the axis of the impression cylinder 100 than the outer peripheral surface thereof. Gap portions 105a are formed in the gap guard 105. Thanks to the gap portions 105a, the front end side of the paper sheet 1 can be held by the grippers 103 and the like. The gap portions 105a also allows the paper sheet 1 to be transferred between the impression cylinder 100 and each of the transfer cylinders 26d and 26e.

Note that, in FIG. 4, reference numeral 104 is a cam follower for turning the gripper shaft 102. In this embodiment as has been described thus far, the gripper pads 101, the gripper shaft 102, the grippers 103 and the like constitute sheet-holding means.

In addition, as shown in FIGS. 1 to 3, a rotary screen apparatus 200 faces and is brought in contact with the impression cylinder 100 of the screen printing unit 20e at a position further downstream in the rotational direction of the impression cylinder than the transfer cylinder 26d. The rotary screen apparatus 200 has the following structure.

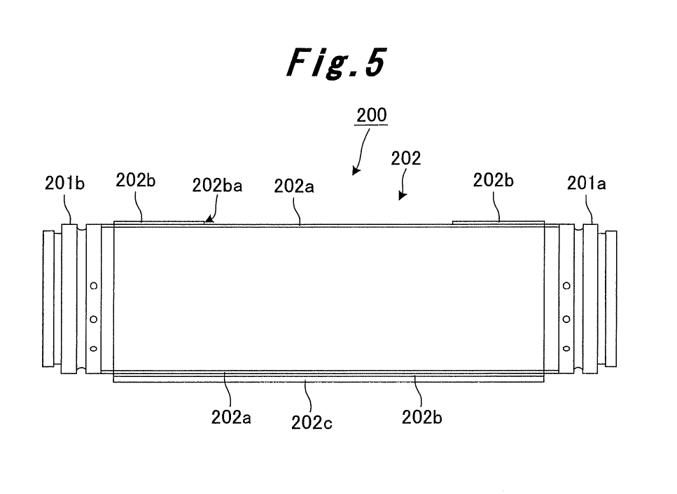

As shown in FIG. 5, cylindrical flanges 201a and 201b, which are supporting members, and which are rotatably supported, support the two end portions of a screen 202, which is a cylindrical plate made of nickel. Small holes corresponding to a pattern are formed in the peripheral surface of the screen 202. As shown in FIGS. 2 and 3, an ink reservoir portion 203 where a special ink 2, which is a liquid, is pooled is provided inside the screen 202. A squeegee 204 is also provided inside the screen 202. The squeegee 204 squeezes out and supplies the special ink 2 in the ink reservoir portion 203 to the outside of the screen 202 through the small holes formed in the screen 202.

As shown in FIGS. 3 and 5, the screen 202 has a three-layer structure with a base layer 202a, a protection layer 202b and a reinforcement layer 202c. The base layer 202a is cylindrical and is made of nickel. Small holes corresponding to a pattern is formed in the peripheral surface of the base layer 202a. The protection layer 202b is also cylindrical and is also made of nickel. The protection layer 202b has a square-shaped gap portion 202ba. The gap portion 202ba is configured to allow the paper sheet 1 to be fitted thereinto when the gap portion 202ba faces the paper sheet 1 held on the outer peripheral surface of the impression cylinder 100. Thus, the paper sheet 1 is brought into contact with the base layer 202a where the small holes corresponding to the pattern are formed. In addition, the protection layer 202b is formed on the base layer 202a all along the length in the circumferential direction, in a thickness t, which is approximately equal to the thickness of the paper sheet 1. The reinforcement layer 202c is arc-shaped, and is made of nickel. The reinforcement layer 202c is formed on the protection layer 202b, so that the reinforcement layer 202c covers the gap portion 100a when the reinforcement layer 202c faces the gap portion 100a of the impression cylinder 100. The reinforcement layer 202c has a thickness equal to the shortest distance between the surface of the gap guard 105 and the tracing of the outer peripheral surface of the impression cylinder 100 so that the reinforcement layer 202c may roll on the gap guard 105.

In other words, the screen 202 has the following structure. The portion facing the surface of the paper sheet 1 held on the outer peripheral surface of the impression cylinder 100 has nothing but the base layer 202a. Additionally, the protection layer 202b is formed on a portion of the base layer 202a that faces a portion of the outer peripheral surface of the impression cylinder 100, in which no paper sheet 1 is held all along the length in the axial direction. The protection layer 202b is formed continuously all along the length in the rotational direction. Moreover, the reinforcement layer 202c is formed continuously all along the length in the rotational direction on the protection layer 202b that faces the gap portion 100a of the impression cylinder 100.

As shown in FIG. 1, the impression cylinder 100 of the screen printing unit 20e faces and is brought into contact with the transfer cylinder 26e at a position further downstream in the rotational direction of the impression cylinder 100 than the rotary screen apparatus 200. An example of such a transfer cylinder 26e is a skeleton cylinder (solid cylinder) with a guiding unit 27b which is provided therebelow, and which blows out air to guide the transfer of the paper sheet 1, as is described in Japanese Patent Application Publication No. 2004-099314. The transfer cylinder 26e faces and is brought into contact with the transport cylinder 28 of a drying unit 20f at a position further downstream in the rotational direction of the transfer cylinder 26e than the impression cylinder 100. A drying lamp 29, which irradiates ultraviolet rays (UV), is provided at a position further downstream in the rotational direction of the transport cylinder 28 than the transfer cylinder 26e.

The transport cylinder 28 of the drying unit 20f faces and is brought into contact with the delivery cylinder 31 of the delivery unit 30 at a position further downstream in the rotational direction of the transport cylinder 28 than the drying lamp 29. A sprocket 32 is provided coaxially to, and rotatably together with, the delivery cylinder 31. A delivery tray 35 is provided to the delivery unit 30. A sprocket 33 is provided over the delivery tray 35. A delivery chain 34, to which a plurality of unillustrated delivery grippers at certain predetermined intervals are attached, is looped between the sprockets 32 and 33.

Here, explanations will be given of a manufacturing apparatus for manufacturing the screen 202 with the structure described above.

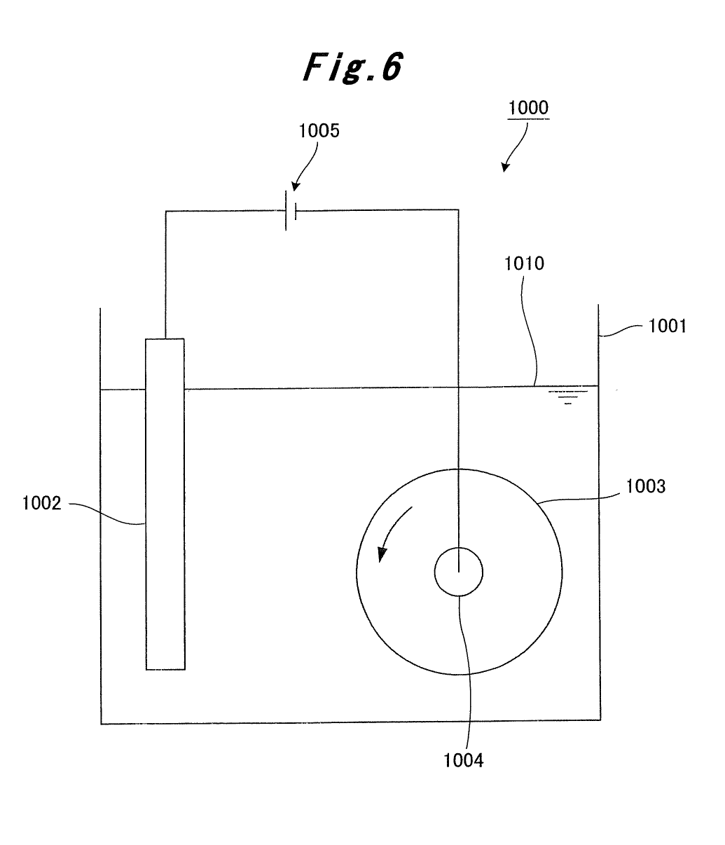

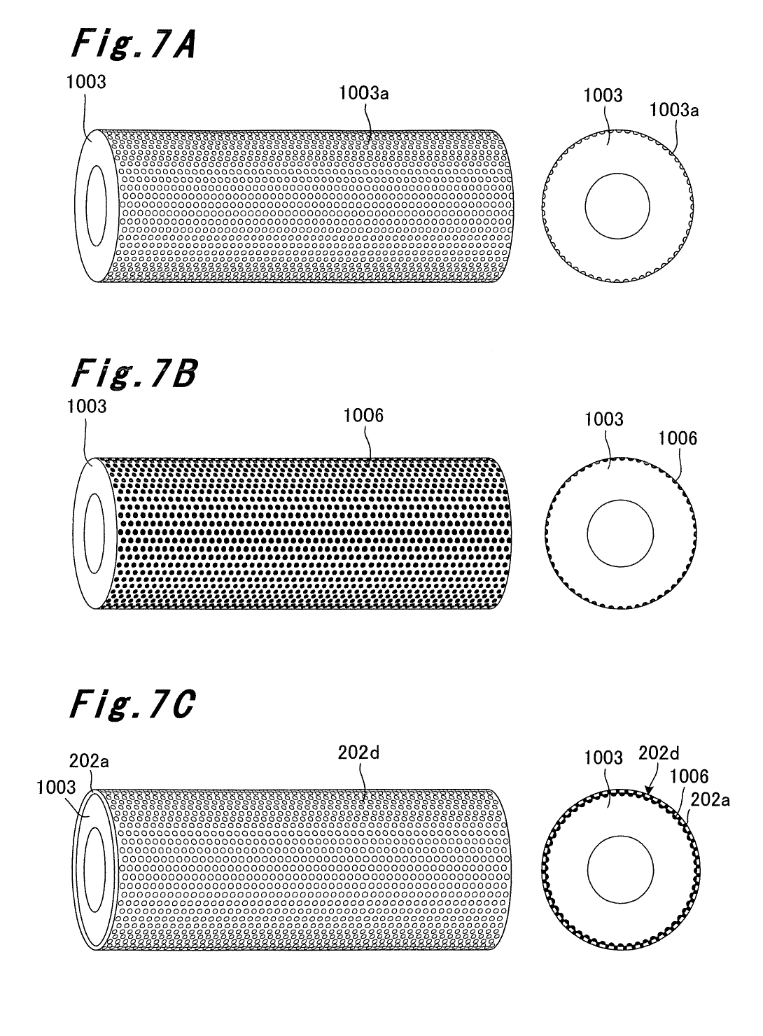

As shown in FIG. 6, a screen manufacturing apparatus 1000 has an electroforming bath 1001, an electrode plate 1002, a mother die 1003, a drive motor 1004 and a DC power supply 1005. An electroforming solution 1010, which is an aqueous solution containing nickel ions, is pooled in the electroforming bath 1001. The electrode plate 1002 is made of nickel, and is placed inside the electroforming bath 1001. The mother die 1003 is made of copper-plated iron or copper, and is cylindrical or columnar. That is, the mother die 1003 has a cylindrical or columnar circumferential surface made of copper. Multiple minute dimples 1003a are formed in the outer peripheral surface of the mother die 1003 (see FIG. 7A). The drive motor 1004 is placed inside the electroforming bath 1001, and is capable of going up and down. The drive motor 1004 detachably supports and drives to rotate the mother die 1003. The drive motor 1004 allows the electric currents flow to the mother die 1003. The DC power supply 1005 has its cathode connected to the electrode plate 1002 and its anode connected to the drive motor 1004.

Subsequently, explanations will be given of a manufacturing method for manufacturing the screen 202 using the screen manufacturing apparatus 1000.

Firstly, to eliminate any irregularity in the outer peripheral surface of the mother die 1003, the dimples 1003a are filled up with a masking material for holes 1006 such as paraffin, resin and tape (see FIG. 7B). The mother die 1003 is attached to the drive motor 1004 of the screen manufacturing apparatus 1000, and then is immersed into the electroforming solution 1010 pooled in the electroforming bath 1001.

Secondly, the DC power supply 1005 is activated to make the electric current flow between the electrode plate 1002 and the mother die 1003 and to make the mother die 1003 driven to rotate by the drive motor 1004. Then, the nickel ions in the electroforming solution 1010 are electrodeposited (plate) on the outer peripheral surface of the mother die 1003 while avoiding the portions corresponding to the masking material 1006 on the outer peripheral surface of the mother die 1003. In this way, the cylindrical base layer (first nickel-plated layer) 202a made of nickel with multiple small holes 202d is formed (electroformed) on the outer peripheral surface of the mother die 1003 (see FIG. 7C). What has been described is a step of electroforming the base layer.

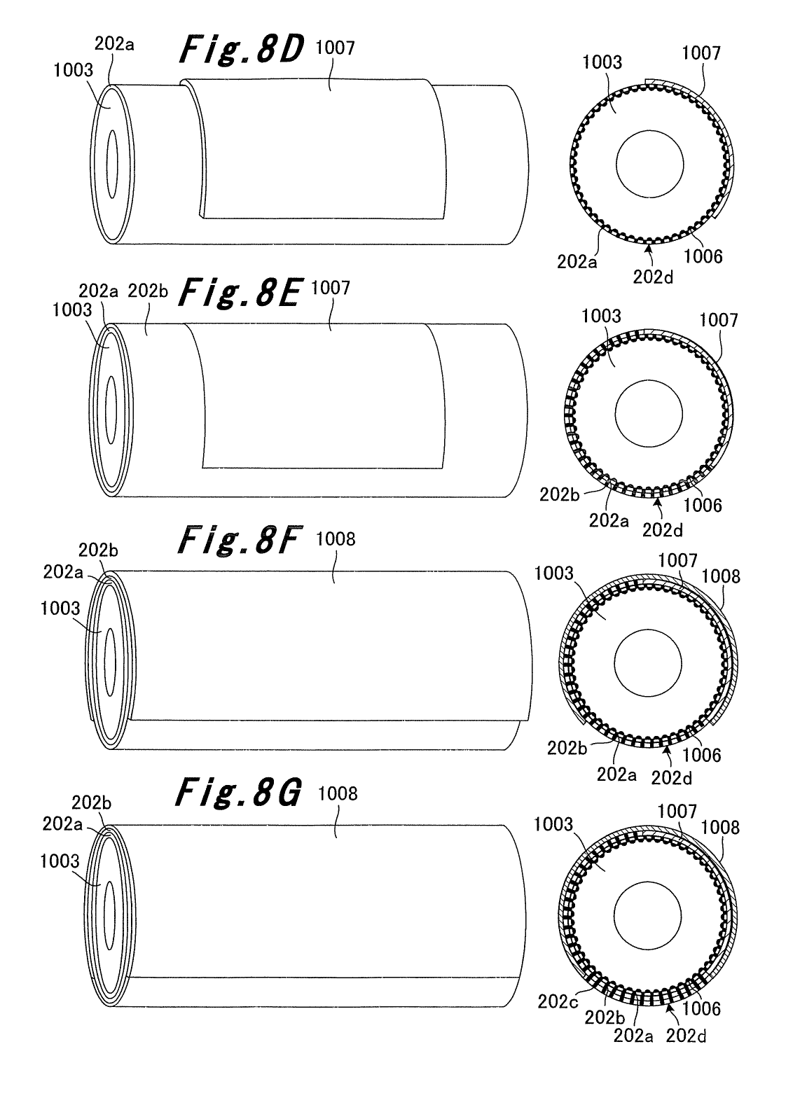

Thirdly, once the base layer 202a is formed in this way, the DC power supply 1005 turns off to stop the flow of the electric current between the electrode plate 1002 and the mother die 1003. At the same time, the rotation of the mother die 1003 that is driven by the drive motor 1004 is stopped, and the mother die 1003 is pulled out of the electroforming solution 1010 pooled in the electroforming bath 1001. Then, a first masking material 1007 (such as gypsum, wooden pattern, resin, and tape) with a shape corresponding to the paper sheet 1 is provided at a certain predetermined place on the base layer 202a. Thus, just a certain predetermined portion (only a part of the base layer) of the surface of the base layer 202a on the outer peripheral surface of the mother die 1003 is made to be exposed (see FIG. 8D). The mother die 1003 is immersed again into the electroforming solution 1010 pooled in the electroforming bath 1001.

Fourthly, the DC power supply 1005 is activated to make the electric current flow between the electrode plate 1002 and the mother die 1003 and to make the mother die 1003 driven to rotate by the drive motor 1004. Then, the nickel ions in the electroforming solution 1010 are electrodeposited (plate) further on the base layer 202a while avoiding the portions corresponding to the masking material for holes 1006 on the outer peripheral surface of the mother die 1003 and the portions corresponding to the first masking material 1007 on the base layer 202a. In this way, the cylindrical protection layer (a second nickel-plated layer) 202b made of nickel with multiple small holes 202d is integrally formed (electroformed) on the base layer 202a. The protection layer 202b has approximately the same thickness t as that of the paper sheet 1. The protection layer 202b has the square-shaped gap portion 202ba into which the paper sheet 1 is fitted to be brought into contact with the base layer 202a when the protection layer 202b faces the surface of the paper sheet 1 held on the outer peripheral surface of the impression cylinder 100 (see FIG. 8E). What has been described is a step of electroforming the protection layer.

Fifthly, once the protection layer 202b is formed in this way, the DC power supply 1005 turns off to stop the flow of the electric current between the electrode plate 1002 and the mother die 1003 for a second time. At the same time, the rotation of the mother die 1003 that is driven by the drive motor 1004 is stopped, for a second time, and the mother die 1003 is pulled, for a second time, out of the electroforming solution 1010 pooled in the electroforming bath 1001. Then, a second masking material 1008 (such as gypsum, wooden pattern and resin) with a shape in which a shape corresponding to the gap portion 100a of the impression cylinder 100 is cut away is provided at a certain predetermined place on the protection layer 202b. Thus, just a certain predetermined portion (only a part of the protection layer 202b) of the surface of the protection layer 202b is made to be exposed (see FIG. 8F). The mother die 1003 is immersed, for a third time, into the electroforming solution 1010 pooled in the electroforming bath 1001.

Sixthly, the DC power supply 1005 is activated to make the electric current flow between the electrode plate 1002 and the mother die 1003 and to make the mother die 1003 driven to rotate by the drive motor 1004. Then, the nickel ions in the electroforming solution 1010 are electrodeposited (plate) further on the protection layer 202b. The plating is carried out as the nickel ions avoid the portions corresponding to the masking material for holes 1006 on the outer peripheral surface of the mother die 1003, the portions corresponding to the first masking material 1007 and the portions corresponding to the second masking material 1008 on the protection layer 202b. In this way, the arc-shaped reinforcement layer (a third nickel-plated layer) 202c made of nickel with multiple small holes 202d is integrally formed (electroformed) on the protection layer 202b. The reinforcement layer 202c covers the gap portion 100a and rolls on the gap guard 105 when the reinforcement layer 202c faces the gap portion 100a of the impression cylinder 100 (see FIG. 8G). What has been described is a step of electroforming the reinforcement layer.

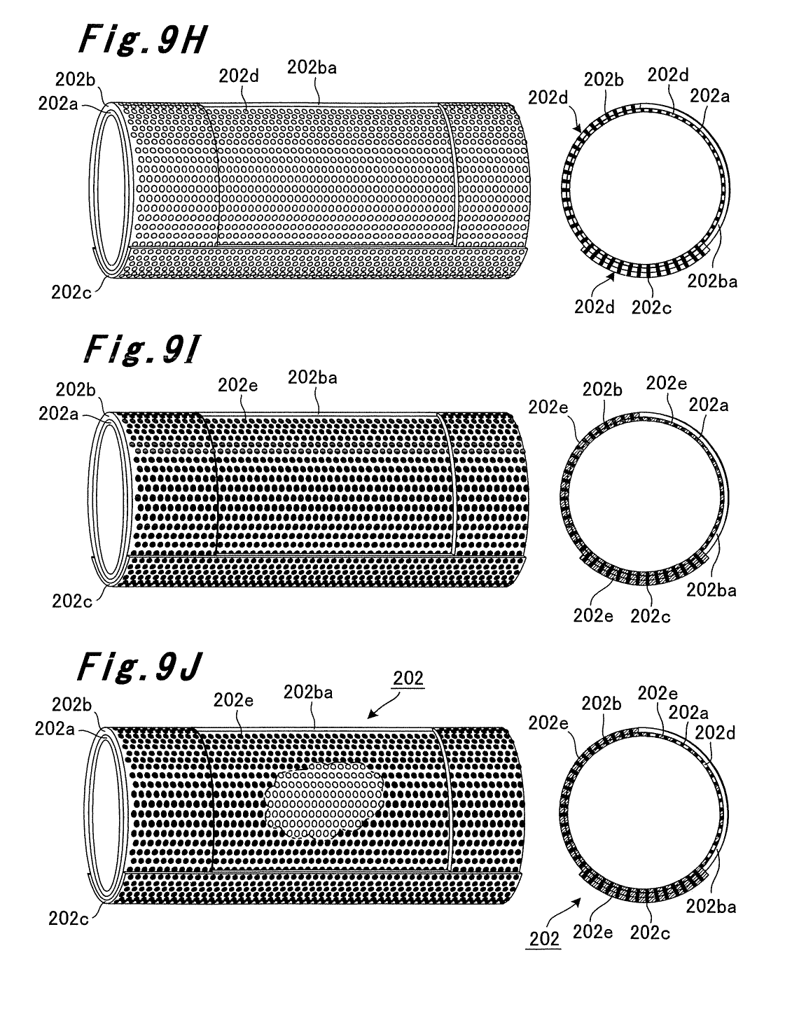

Seventhly, once the reinforcement layer 202c is formed in this way, the DC power supply 1005 turns off to stop the flow of the electric current between the electrode plate 1002 and the mother die 1003 for a third time. At the same time, the rotation of the mother die 1003 that is driven by the drive motor 1004 is stopped, for a third time, and the mother die 1003 is pulled, for a third time, out of the electroforming solution 1010 pooled in the electroforming bath 1001. Then, by removing the mother die 1003, the masking materials 1007 and 1008 after the drive motor 1004 is removed from the mother die 1003, the manufacturing (electroforming) of a master pattern of the screen 202 can be completed (see FIG. 9H).

Finally, once the master pattern of the screen 202 is manufactured, a screen 202 with a shape and a structure, both of which have been described in the forgoing portion, can be manufactured in the following manner. A photosensitive material 202e for plate-making is provided onto the outer peripheral surface of the screen 202 so that all the small holes 202d are filled up with the photosensitive material 200e (see FIG. 91). After that, the screen 202 is exposed to light with a pattern targeted to a portion of the base layer 202a of the square-shaped gap portion 202ba into which the paper sheet 1 is fitted to be brought into contact with the base layer 202a. Thus, the photosensitive material 202e in a portion corresponding to the pattern is removed. What has been described is a step of forming patterned holes.

Subsequently, explanations will be given of the advantages of the printing press of this embodiment, which has a configuration described above.

The paper sheet 1 fed, one by one, from the feeder tray 11 of the feeder 10 to the feeder board 12 is transferred, with use of the swing arm shaft pregripper 13, to the impression cylinder 21a of the first offset printing unit 20a of the printing unit 20. Meanwhile, ink and dampening water are supplied, from the ink supplying unit 24a and the damping unit 25a of the first offset printing unit 20a, respectively, to the plate cylinder 23a, and then from the plate cylinder 23a to the blanket cylinder 22a. Then, the paper sheet 1 receives the ink transferred from the blanket cylinder 22a, and thus the resultant paper sheet 1 is subjected to the printing with a first color. Then, the resultant paper sheet 1 is transferred to the impression cylinder 21b of the second offset printing unit 20b via transfer cylinder 26a. As is the case of the first offset printing unit 20a, the paper sheet 1 is subjected to the printing with a second color in the second offset printing unit 20b. Then, similarly, the paper sheet 1 is subjected to the printing with a third color and to that with a fourth color in the third and the fourth offset printing units 20c and 20d, respectively. After that, via the transfer cylinder 26d, the gripping of paper sheet 1 is changed to the gripper pads 101 and the grippers 103 of the impression cylinder 100 of the screen printing unit 20e.

In the rotary screen apparatus 200 of the screen printing unit 20e, thickly embossed printing corresponding to a pattern with the special ink 2 is carried out on a paper sheet 1 in the following manner. Rotation of the impression cylinder 100 makes the screen 202 rotate, and thus the paper sheet 1 held on the outer peripheral surface of the impression cylinder 100 is fitted in the gap portion 202ba of the protection layer 202b of the screen 202. The special ink 2 in the ink reservoir portion 203 is squeezed out, with the squeegee 204, through the small holes 202d which correspond to the pattern and which are formed in the base layer 202a of the portion corresponding to the gap portion 202ba. In this way, the thickly embossed printing is carried out.

At this time, in the rotary screen apparatus 200, the screen 202 has the protection layer 202b, which is formed on the base layer 202a, and which has approximately the same thickness t as that of the paper sheet 1. The protection layer 202b continues all along the length in the rotational direction, and is formed on the portion of the base layer 202a that faces the outer peripheral surface of the impression cylinder 100 where no paper sheet is held all along the length in the axial direction. Suppose that the squeegee 204, which biases the screen 202 outwards in a radial direction, transfers to the outer peripheral surface of the impression cylinder 100, from the paper sheet 1, which is held on the outer peripheral surface of the impression cylinder 100. Thanks to the configuration described above, the squeegee 204 is prevented from falling down from the top of the paper sheet 1 to the top of the impression cylinder 100.

As a result, in the rotary screen apparatus 200, the abrupt pulling of the screen 202 outwards in a radial direction is prevented, so that the damage to the screen 202 can be made extremely small.

The paper sheet 1, then, transfers from the impression cylinder 100, via the transfer cylinder 26e, to the transport cylinder 28 of the drying unit 20f. After the special ink 2 printed on the paper sheet 1 is dried by the UV rays emitted from the drying lamp 29, the paper sheet 1 transfers to the delivery cylinder 31 of the delivery unit 30. The paper sheet 1 is transported by the travel of the delivery chain 34 with use of the delivery gripper, and then is discharged to the delivery tray 35.

In other words, in this embodiment, the outer peripheral surface of the screen 202 is formed so that the squeegee 204 for the rotary screen apparatus 200 of the screen printing unit 20e cannot move in a radial direction of the screen 202.

Accordingly, in this embodiment, the screen 202 for the rotary screen apparatus 200 of the screen printing unit 20e is prevented from being abruptly pulled outwards in a radial direction.

As a result, according to this embodiment, the damage to the screen 202 for the rotary screen apparatus 200 of the screen printing unit 20e can be made extremely small. Thus, the service life of the screen 202 can be prolonged.

Note that the protection layer 202b of the screen 202 may have approximately the same thickness t as the thickness of the paper sheet 1. The difference between the above two thicknesses should be within such a range that the screen 202 may not be abruptly pulled outwards in a radial direction when the screen 202 moves from the paper sheet 1 held on the outer peripheral surface of the impression cylinder 100 to the outer peripheral surface of the impression cylinder 100.

Additionally, to cover the gap portion 100a when the screen 202 faces the gap portion 100a of the impression cylinder 100, the screen 202 has a reinforcement layer 202c formed on the protection layer 202b. To this end, the reinforcement layer 202c is made continuous all along the length of the gap portion 100a in the rotational direction. Thus, when the screen 202 faces the gap portion 100a of the impression cylinder 100, the screen 202, even with the base layer 202a being made thin, can surely prevent the squeegee 204 from falling down into the gap portion 100a of the impression cylinder 100. As a result, the abrupt pulling of the screen 202 outwards in a radial direction can surely be prevented, and the damage to the screen 202 can be reduced. Eventually, the screen 202 can have an even longer service life.

Moreover, the impression cylinder 100 has a gap guard 105 in the gap portion 100a. The reinforcement layer 202c of the screen 202 has a thickness equal to the shortest distance between the surface of the gap guard 105 and the tracing of the outer peripheral surface of the impression cylinder 100 so that the reinforcement layer 202c may roll on the gap guard 105. Thus, when the screen 202 faces the gap portion 100a of the impression cylinder 100, the screen 202 can more surely prevent the squeegee 204 from falling down into the gap portion 100a of the impression cylinder 100. As a result, the abrupt pulling of the screen 202 outwards in a radial direction can more surely be prevented, and the damage to the screen 202 can further be reduced. Eventually, the screen 202 can more surely have an even longer service life.

Furthermore, the manufacturing of the screen 202 that has each of the integrated layers 202a to 202c made of nickel is done by the electroforming in the electroforming solution 1010, which is an aqueous solution containing nickel ions. As a result, these layers adhere much more tightly to one another so that the screen 202 can have a longer service life even more securely.

Still furthermore, conventionally, when the screen moves from the portion over the gap portion of the impression cylinder to the surface of the paper sheet with a thickness of t1, which is larger than the thickness t (t1>t), the screen is sometimes pushed abruptly inwards in a radial direction by a length equivalent to the difference between the thicknesses (t1−t). The pushing causes an impact that may possibly damage the screen. Also conventionally, when the screen moves from the portion over the gap portion of the impression cylinder to the surface of the paper sheet with a thickness of t2, which is smaller than the thickness t (t2<t), the screen is sometimes pulled abruptly outwards in a radial direction by a length equivalent to the difference between the thicknesses (t−t2). The pulling causes an impact that may possibly damage the screen. In this embodiment, however, it is easy to provide the protection layer 202b with a thickness approximately the same as the thickness of the paper sheet currently used, though various paper sheets with different thicknesses are used. As a result, when the screen 202 moves from the portion over the gap portion 100a of the impression cylinder 100 to the surface of the paper sheet with a thickness t1 (t1>t), or t2 (t2<t), it is easy to prevent the abrupt pushing inwards, or pulling outwards, of the screen in a radial direction by a length equivalent to the difference between the thicknesses. The damage to the screen 202 can surely be reduced.

### Other Embodiments

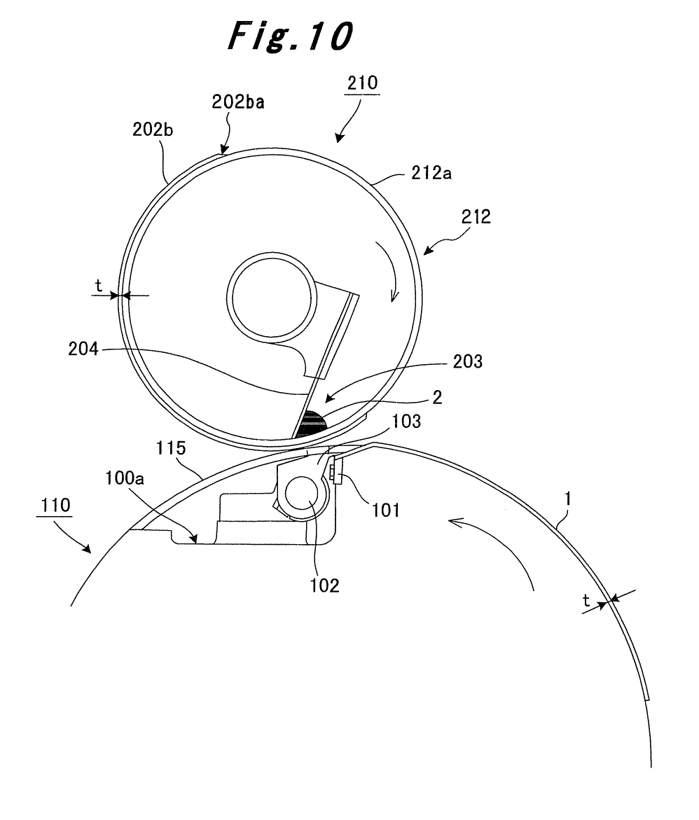

In the first embodiment, explanations have been given of the case of the screen 202 of a three-layer structure, which has the reinforcement layer 202c formed on the protection layer 202b. The reinforcement layer 202c is continuous all along the length of the gap portion 100a in the rotational direction so that the reinforcement layer 202c can cover the gap portion 100a when the screen 202 faces the gap portion 100a of the impression cylinder 100. As a second embodiment, for example, a screen 212 can have a two-layer structure as shown in FIG. 10. The screen 212 has a base layer 212a, which is thicker than the base layer 202a in the first embodiment, while the reinforcement layer 202c in the first embodiment is omitted.

In the first embodiment, the reinforcement layer 202c, with a thickness equivalent to the shortest distance between the surface of the gap guard 105 and the tracing of the outer peripheral surface of the impression cylinder 100, is used so that the screen 202 can roll on the gap guard 105. On the other hand, in the second embodiment, the screen 212 is made to roll on a gap guard 115 by using an impression cylinder 110 with the following features. The impression cylinder 110 has the gap guard 115, which is a cover member. The gap guard 115 is provided to the gap portion 100a so as to exactly overlap the tracing of the outer peripheral surface of the impression cylinder 110 on which the paper sheet 1 is held. In other words, the gap guard 105 of the first embodiment is provided to the gap portion 100a so that the surface of the gap guard 105 (the surface for guiding the screen 202) can be positioned at an inner side in the radial direction than the outer peripheral surface of the impression cylinder 100. On the other hand, as shown in FIG. 10, the gap guard 115 is provided to the gap portion 100a so that the surface of the gap guard 115 (the surface for guiding the screen 212) can have the same curvature as that of the outer peripheral surface of the impression cylinder 110 to make the two surfaces continuous.

The screen 212 of the second embodiment can be manufactured by the method of manufacturing the screen 202 described in the first embodiment, but the step of manufacturing the reinforcement layer 202c (step of electroforming the reinforcement layer, FIGS. 8F and 8G) is omitted. As a result, the work of manufacturing can be simplified, and the manufacturing cost can be lowered.

In the screen 202 of the first embodiment, however, the base layer 202a can be made thinner, and the thinly embossed printing can be carried out easily. For this reason, the screen 202 of the first embodiment is highly preferable.

In the above-described embodiments, explanations have been given as to the case of using the screens 202 and 212, each with a cylindrical protection layer 202b with a square-shaped gap portion 202ba formed therein. The paper sheet 1 is fitted in the gap portion 202ba when each of the screens 202 and 212 faces the surface of the paper sheet 1 held on the outer peripheral surface of each of the impression cylinders 100 and 110. The paper sheet 1 is fitted in the gap portion 202ba to bring the portion of the base layer 202a and 212a where small holes 202d are formed as corresponding to a pattern into contact with the paper sheet 1. As a third embodiment, for example, a screen that has a protection layer with a C-shaped cross section can be used. In the protection layer of the screen, a portion of the base layer 202a is cut away all along the length in the axial directions to form a gap portion. When the screen faces the surface of the paper sheet 1 held on the outer peripheral surface of each of the impression cylinders 100 and 110, the paper sheet 1 is fitted in the gap portion. At that time, the portion of the base layer 202a where small holes 202d are formed as corresponding to a pattern is brought into contact with the paper sheet 1. In other words, a screen with a protection layer formed only on a part of each of the base layers 202a and 212a can be used, the portion facing a portion of the outer peripheral surface of each of the impression cylinders 100 and 110 where no paper sheet 1 is held all along the length in the axial directions.

The screen of the third embodiment can be manufactured in a similar way to the screen 202 of the first embodiment. However, the first masking material 1007 with a shape corresponding to the paper sheet 1, which is used in the method of manufacturing the screen 202 described in the first embodiment, is replaced by a first masking material extending all along the length of the screen in the axial directions.

In addition, the protection layer can be formed only in a part of the screen in the axial directions, instead of the protection layer formed all along the length of the screen in the axial directions. For example, the protection layer can be formed only on the two end portions of the screen in the axial directions, leaving only a base layer in the center portion of the screen in the axial directions.

However, each of the screens 202 and 212, in the above-described embodiments, has a cylindrical protection layer 202b, in which the square-shaped gap portion 202ba is formed to allow the paper sheet 1 to be fitted therein, so that the screens have the following advantages. When the special ink 2 is squeezed with the squeegee 204 out to the surface of the paper sheet 1 held on the outer peripheral surface of the impression cylinder 100, the bowing of each of the screens 202 and 212 in the axial directions can be prevented. Then, the deformation of each of the screens 202 and 212 in the axial directions can also be prevented. As a result, the damage to each of the screens 202 and 212 can be reduced, and then each of the screens 202 and 212 can have a longer service life. Thus, the screens 202 and 212 are strongly preferable.

In the above-described embodiments, the gap guards 105 and 115 are provided to the gap portion 100a of the impression cylinders 100 and 110, respectively. In a case where each of the screens 202 and 212 has a sufficient thickness, the corresponding gap guards 105 and 115 can be omitted.

In the above-described embodiments, using the mother die 1003 in which multiple minute dimples 1003a formed on the circumferential surface are filled up with the masking material for holes 1006, the small holes 202d are formed while the base layer 202a is electroformed (mesh-electroformed). In addition, in manufacturing the screen 202 and 212, the small holes 202d are filled up with the photosensitive material for plate-making 202e, and then the portion corresponding to the pattern is exposed to light. However, as a fourth embodiment, for example, the manufacturing of a screen in the following way can be possible. To begin with, a mother die, which has no dimples or the like formed in the circumferential surface, and which has a cylindrical or a columnar shape, is used, and is electroformed. Thus, a master cylinder for screens 202 and 212 is manufactured with no small holes. Small holes corresponding to a pattern are formed on the base layer by laser-processing, by discharge-machining, by drilling, or the like (step of forming patterned holes). Alternatively the screen 202 and 212 can be manufactured in the following way. To begin with, a mother cylinder, which has no dimples formed in the circumferential surface, and which has a cylindrical or a column shape, is used, and is electroformed. Thus, a master cylinder for screens 202 and 212 is manufactured with no small holes. Multiple small holes are formed only in a part of the base layer, which is exposed in the square-shaped gap portion, by laser-processing, by discharge-machining, by drilling, or the like. Then, the small holes 202d are filled up with the photosensitive material for plate-making, and then the part corresponding to the pattern is exposed.

However, the screens 202 and 212 manufactured as in the above-described embodiments, specifically, by mesh-electroforming the small holes 202d, then filling the small holes 202d up with a photosensitive material for plate-making 202e, and then exposing the portion corresponding to a pattern to light, are strongly preferable due to the following reason. The photosensitive material 202e is removed from the screens 202 or 212 by washing after use. Then, the small holes 202d are filled up with a new photosensitive material 202e again. And then, the portion corresponding to a new pattern is exposed to light. Thus, the screens 202 and 212 can easily be reused as a new screen 202 or 212.

In the above-described embodiments, the cylindrical screens 202 and 212 are manufactured by electroforming with use of the cylindrical or columnar mother die 1003. However, as a fifth embodiment, a cylindrical screen can be made in the following way. To begin with, a plate-shaped master material is manufactured by electroforming with use of, for example, a plate-shaped mother die. Then, the two end portions of the master material are joined by rolling up the master material to form a cylindrical shape.

However, as in the above-described embodiments, the manufacturing of the cylindrical screens 202 and 212 by electroforming can be made easier than otherwise with the use of a cylindrical or columnar mother die 1003. Thus, the use of a cylindrical or columnar mother die 1003 is strongly preferable.

In the above-described embodiments, explanations have been given of the case in which the gripper pads 101, the gripper shaft 102, the grippers 103 and the like constitute sheet-holding means. However, as a eighth embodiment, a suction holder, a suction means and a suction holding means can constitute sheet-holding means, as is described in Japanese Patent Application Publication No. 2001-225445. The suction holder is provided to the gap portion formed in the outer peripheral surface of the impression cylinder, and a suction mouth is opened on the surface of the suction holder. The suction means is connected to the suction holder. The suction holding means is provided between the suction holder and the suction means. When the suction holder receives a sheet, switching means provided to the suction holding means allows the suction holder and the suction means to communicate with each other. On the other hand, when the suction holder hand over a sheet, the switching means cuts off the communication between the suction holder and the suction means.

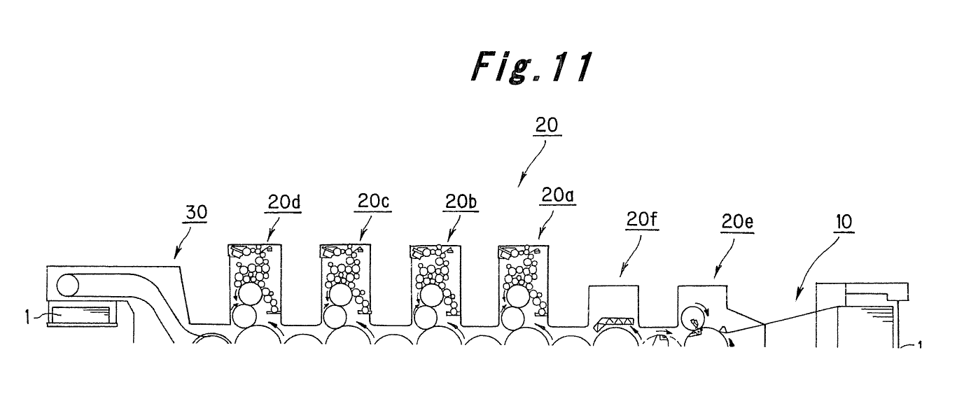

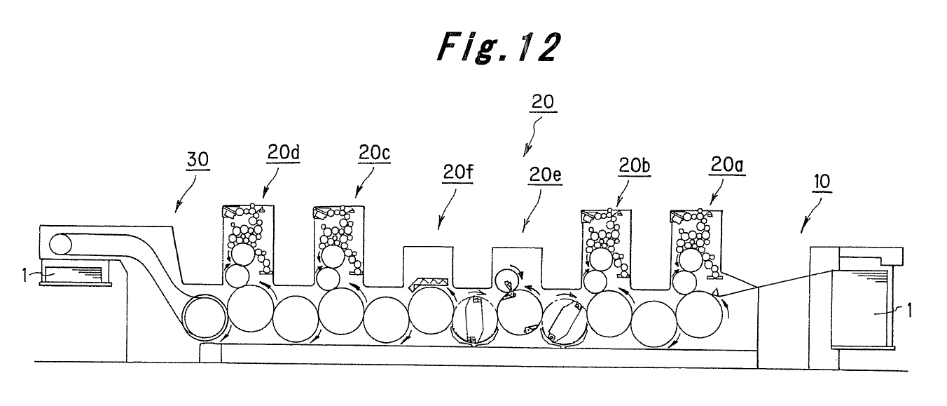

In the above-described embodiments, explanations have been given of the case in which the screen printing unit 20e and the drying unit 20f are placed in places at the downstream side of the first to the fourth offset printing units 20a to 20d. However, as a ninth embodiment, the screen printing unit 20e and the drying unit 20f can be placed in places at the upstream side of the first to the fourth offset printing units 20a to 20d as shown in FIG. 11. Alternatively, the screen printing unit 20e and the drying unit 20f can be placed in places between the second offset printing unit 20b and the third offset printing unit 20c, as shown in FIG. 12.

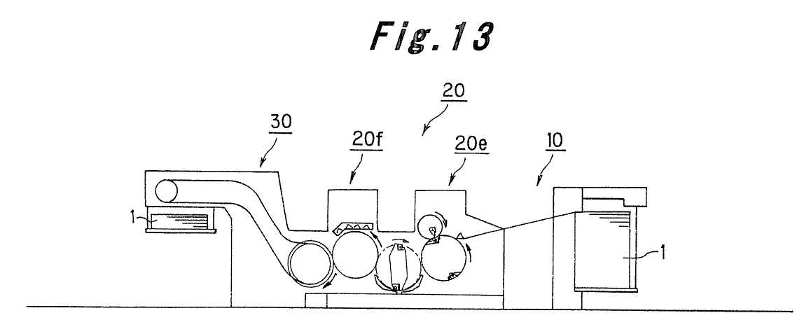

In the above-described embodiments, explanations have been given of the case in which the liquid supply apparatus of the present invention is applied to the printing press with the offset printing units 20a to 20d and the screen printing unit 20e being combined together. However, as a tenth embodiment, for example, the liquid supply apparatus can be applied to a screen printing press that does not have any offset printing unit but the feeder 10, the screen printing unit 20e, the drying unit 20f and the delivery unit 30, as shown in FIG. 13. The liquid supply apparatus can be applied also to a processing unit other than a printing unit. For example, it can be applied to a rotary punching machine.

In the above-described embodiments, explanations have been given of the case in which the liquid supply apparatus of the present invention is applied to the screen printing unit 20e. The screen printing unit 20e performs thickly embossed printing on the paper sheet 1 with the special ink 2. The special ink 2 is pooled inside the screen 202 for the rotary screen apparatus 200, and is squeezed out, by the squeegee 204, through the small holes formed in the screen 202 when thickly embossed printing is performed. The present invention is not limited to such embodiments. As long as a liquid is supplied, by a squeegee, to a sheet held on a impression cylinder, though holes formed in a plate for rotary screen apparatus, the liquid supply apparatus of the present invention can be applied, in a similar way to the case of the above-described embodiments. For example, the liquid supply apparatus can be applied when used as a coating apparatus in a case where a paper sheet is coated with varnish which is pooled inside the screen for rotary screen apparatus, and which is squeezed out by a squeegee through the small holes formed in the screen.

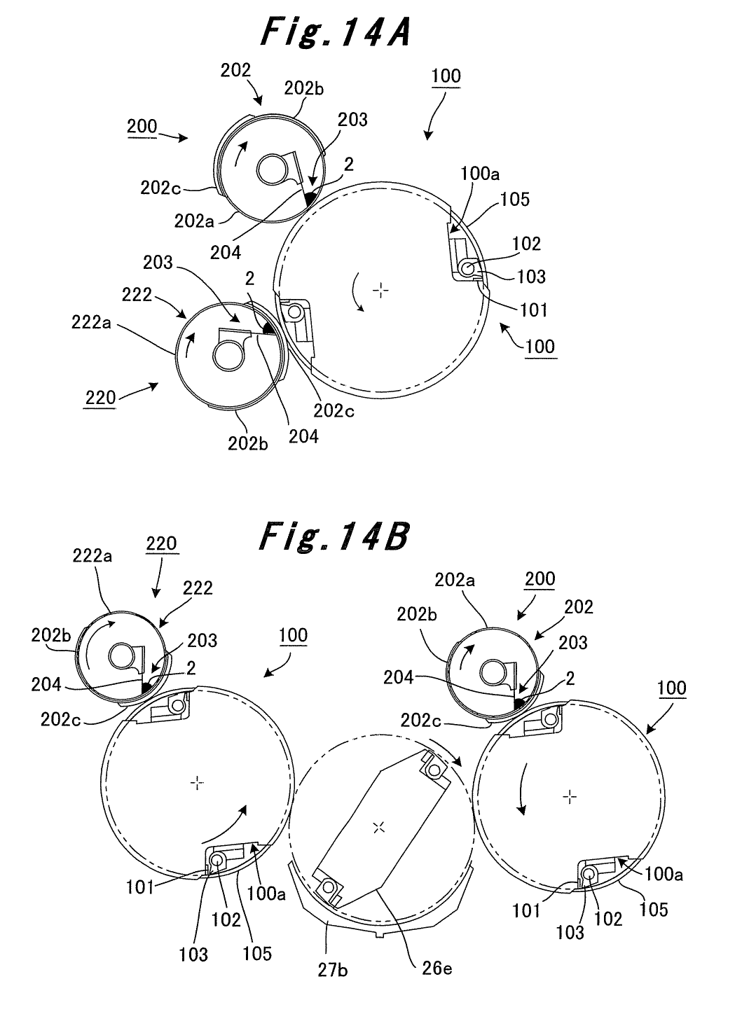

In the above-described embodiments, explanations have been given of the case in which the screen printing unit 20e equipped with a single rotary screen apparatus 200 or 210 is applied to a printing press or the like. However, as a tenth embodiment, for example, the screen printing unit may be constituted by two rotary screen apparatuses 200 and 220 placed around the single impression cylinder 100 so that the two apparatuses can face and be brought into contact with the impression cylinder 100 (satellite-type cylinder arrangement), as shown in FIG. 14A. In addition, an additional impression cylinder 100 may be further provided to face and to be brought into contact with the transfer cylinder 26e at the downstream side in the rotational direction of the transfer cylinder 26e. A rotary screen apparatus 220 may be further provided to face and to be brought into contact with the additional cylinder 100, (unit-type cylinder arrangement), as shown in FIG. 14B. With these configurations, thickly embossed printing can be performed on the paper sheet 1 with two kinds of special ink 2.

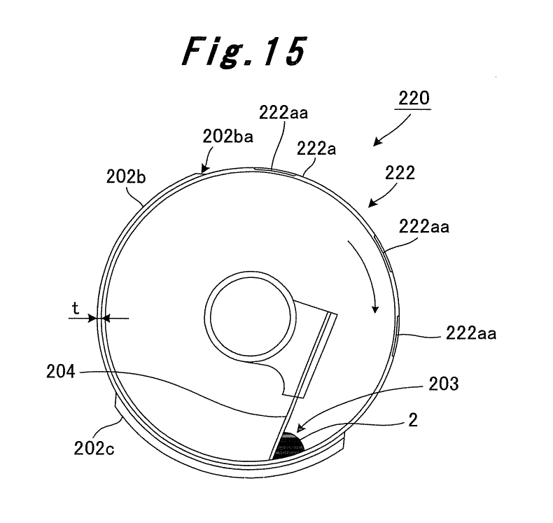

Here, the rotary screen apparatus 220 placed at the downstream side has a screen 222 with a base layer 222a in which tripping grooves 222aa are formed, as shown in FIG. 15. The tripping grooves 222aa correspond to a pattern formed in a base layer 202a of the screen 202 of the rotary screen apparatus 200 placed at the upstream side. Thus, suppose that printing is performed on the paper sheet 1 by the rotary screen apparatus 220 placed at the downstream side. In this case, the special ink 2 or the like, having been printed by thickly embossed printing on the paper sheet 1 by the rotary screen apparatus 200 placed at the upstream side, can be prevented from adhering to the screen 222 of the rotary screen apparatus 220 placed at the downstream side, or can be prevented from being crushed.

Note that the screen 222, with the base layer 222a in which the tripping grooves 222aa are formed, can be manufactured easily in the following way. The electroforming operation is stopped once in the course of the step of electroforming the base layer (for example, FIG. 7C). A masking material for tripping groove, which masking material is in a shape corresponding to the pattern formed in the screen 202 of the rotary screen apparatus 200 placed at the upstream side, is provided at a certain predetermined position on the base layer 222a. After that, an electroforming operation is restarted.

In the plate for rotary screen apparatus of the present invention, even when the plate moves from the sheet held on the outer peripheral surface of the impression cylinder to the outer peripheral surface of the impression cylinder, the squeegee is prevented from falling down from the sheet onto the impression cylinder. For example, the plate for rotary screen apparatus is applied to the screen for the screen printing unit of the printing press. In such a case, a special ink or the like is squeezed out by a squeegee through holes to perform printing on a paper sheet held on the impression cylinder. Even in such a case, the screen is never abruptly pulled outwards in a radial direction. As a result, damage to the screen can be suppressed, and the service life of the screen can be prolonged. Thus, the plate for rotary screen apparatus of the present invention can be useful when it is used in the printing industry and the like.

The invention thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of manufacturing a plate for rotary screen apparatus comprising:
forming a first nickel-plated layer by plating nickel on a mother die; and
forming a second nickel-plated layer by plating nickel on a surface where the first nickel-plated layer is exposed after a first masking material is provided on a surface of the first nickel-plated layer so that a part of the surface of the first nickel-plated layer may be exposed.

2. The method of manufacturing a plate for rotary screen apparatus according to claim 1, further comprising:
forming a third nickel-plated layer by plating nickel on a surface where the second nickel-plated layer is exposed after a second masking material is provided on a surface of the second nickel-plated layer so that a part of the surface of the second nickel-plated layer may be exposed.

3. The method of manufacturing a plate for rotary screen apparatus according to claim 1, wherein,
the nickel plating is performed while the mother die is made to rotate.

4. The method of manufacturing a plate for rotary screen apparatus according to claim 3, wherein,
the mother die is in any one of a cylindrical shape and a columnar shape.

5. The method of manufacturing a plate for rotary screen apparatus according to claim 1, wherein,
multiple dimples are provided in an outer surface of the mother die, and the dimples of the mother die are filled up with a masking material for holes.

6. The method of manufacturing a plate for rotary screen apparatus according to claim 1, wherein,
after the plate for rotary screen apparatus is formed by the nickel-plated layers, the plate is subjected to the steps of:
filling up, with a photosensitive material, multiple holes formed in surfaces of the nickel-plated layers; and
removing the photosensitive material from the holes in the nickel-plated layers, the holes corresponding to a pattern.

7. A plate for rotary screen apparatus which is in a cylindrical shape, which is rotatably supported so that the plate can face and be brought into contact with an impression cylinder that holds a sheet on the outer peripheral surface thereof, which has holes formed in the circumferential surface thereof, and which supplies liquid pooled inside the plate to the sheet through the holes with a squeegee placed inside the plate,
the plate for rotary screen apparatus wherein,
the plate is made of nickel plating, and
at least a part, in an axial direction, of the portion facing a portion of the outer peripheral surface of the impression cylinder, on which portion of the outer peripheral surface no sheet is held, has a thickness made up by adding the thickness of the sheet and the thickness of a portion facing a surface of the sheet held on the outer peripheral surface of the impression cylinder.

8. The plate for rotary screen apparatus according to claim 7, wherein,
the portion with the thickness made up by adding the thickness of the sheet and the thickness of the portion facing the surface of the sheet held on the outer peripheral surface of the impression cylinder, is provided continuously all along the length, in the rotational direction, of the portion of the plate for rotary screen apparatus, which portion faces the portion of the outer peripheral surface of the impression cylinder, where no sheet is held all along the length in the axial directions.

9. The plate for rotary screen apparatus according to claim 7, wherein,
the portion facing the surface of the sheet held on the outer peripheral surface of the impression cylinder is composed of a base layer with holes formed in the circumferential surface thereof, and
the portion, with the thickness made up by adding the thickness of the sheet and the thickness of the portion facing the surface of the sheet held on the outer peripheral surface of the impression cylinder, is composed of the base layer and a protection layer which is provided thereon, and which has a thickness equal to that of the sheet.

10. The plate for rotary screen apparatus according to claim 7, wherein,
the impression cylinder includes a cover member in a gap portion formed in the outer peripheral surface of the impression cylinder so that sheet-holding means for holding the front end side of the sheet to make the sheet held on the outer peripheral surface can be installed in the gap portion, the cover member enabling the sheet-holding means to hold the sheet and connecting between an end of the gap portion at the downstream side in the rotational direction and an end at the upstream side,
the portion of the plate for rotary screen apparatus, which portion faces the surface of the sheet held on the outer peripheral surface of the impression cylinder, is composed of a base layer with holes formed in the circumferential surface thereof,
the portion with the thickness made up by adding the thickness of the sheet and the thickness of the portion of the plate for rotary screen apparatus, which portion faces the surface of the sheet held on the outer peripheral surface of the impression cylinder, is composed of the base layer and a protection layer formed thereon, the protection layer having a thickness equal to the thickness of the sheet, and
on the protection layer formed on the base layer, a reinforcement layer, with a thickness equal to the length of the shortest distance between the tracing of the outer peripheral surface of the impression cylinder and the surface of the cover member, is formed so that at least a part, in the axial directions, of the portion of the plate for rotary screen apparatus, which portion faces the cover member of the impression cylinder, can have a thickness made up by adding the thickness of the sheet, the thickness of the portion of the plate for rotary screen apparatus, which portion faces the surface of the sheet held on the outer peripheral surface of the impression cylinder, and the length equivalent to the shortest distance between the tracing of the outer peripheral surface of the impression cylinder and the surface of the cover member.
